(19) United States
(12) Patent Application Publication
(10) Pub. No.: US 2023/0027344 A1
(43) Pub. Date: Jan. 26, 2023

(54) Variationally Optimized Measurement Method and Corresponding Clock Based On a Plurality of Controllable Quantum Systems

(71) Applicant: Alpine Quantum Technologies GmbH, Innsbruck (AT)

(72) Inventors: Raphael Kaubruegger, Innsbruck (AT); Denis Vasilyev, Innsbruck (AT); Peter Zoller, Innsbruck (AT); Klemens Hammerer, Hannover (DE); Marius Schulte, Hannover (DE)

(73) Assignee: Alpine Quantum Technologies GmbH, Innsbruck (AT)

(21) Appl. No.: 17/305,476

(22) Filed: Jul. 8, 2021

(51) Int. Cl. G06N 10/20; G06N 10/40

(52) U.S. Cl. CPC G06N 10/20; G06N 10/40

(57) ABSTRACT

A method of measuring a physical quantity implemented in a hybrid classical-quantum system, the method comprising initializing the plurality of controllable quantum systems in an initial state, applying a set of preparation gates to the plurality of controllable quantum systems for preparing the plurality of controllable quantum systems in a non-classical state, evolving the non-classical state over a time period for obtaining an evolved state of the plurality of controllable quantum systems, applying a set of decoding gates to the plurality of controllable quantum systems in the evolved state, performing a measurement of the plurality of controllable quantum systems, and determining a derived value of the physical quantity based on a mapping function between an outcome of the measurement and the physical quantity on the classical computation system.

### BACKGROUND

To measure a physical quantity in a quantum system, it is common to prepare a probe which is sensitive to the physical quantity, let it interact with the system, and subsequently measure the probe. The value of the physical quantity may then be determined by comparing the input and output states of the probe. However, in practice, any determination of the state of the probe will be associated with a statistical uncertainty. This statistical uncertainty can be reduced by letting N identical probes interact with the system in sequence or in parallel and averaging the result, thereby reducing an estimation error by a factor of 1/\sqrt{N}. Moreover, using quantum effects, it is possible to beat this so-called standard quantum limit, e.g. by squeezing or entangling the states of the identical probes.

A prominent application for the precise measurement of a physical quantity is the frequency control of an oscillator in an atomic clock. In atomic clocks, the oscillator produces a field of electromagnetic radiation at a clock frequency, and the electromagnetic radiation drives a transition between quantum states of the atoms, e.g. in a Ramsey interferometer or Rabi interferometer. Depending on a frequency detuning between the clock frequency and a transition frequency associated with the transition (sometimes also termed resonant frequency), a different proportion of the atoms may end up in respective excited or ground states of the atoms. Accordingly, the atoms may act as probes of the frequency detuning.

A feedback control signal may then be determined from the measurement result to adjust the clock frequency of the oscillator, thereby stabilizing the oscillator frequency with the transition frequency of the atoms. In other words, the transition frequency of the atoms may act as a well-defined frequency reference for the clock frequency of the oscillator. Since an estimation error of the clock frequency can result in erroneous feedback on the oscillator, optimized measurement schemes could therefore improve the stability of atomic clocks.

Giovanetti et al., “Quantum metrology,” arXiv:quant-ph/0509179, discuss the use of quantum effects to improve the estimation error of a phase measurement up to the Heisenberg limit of 1/N. The 1/N limit on the estimation error is identified as an ultimate bound of a phase measurement. The limit can be attained by preparing the states of the probes using quantum effects, such as squeezing and entanglement, before the probes interact with the system under investigation. On the other hand, Giovanetti et al. state that, even though entanglement at the preparation stage would be useful to increase the precision, it would be useless at the measurement stage.

Koczor et al., “Variational-state quantum metrology,” New J. Phys. 22 083038, discuss the use of variational quantum algorithms for magnetic field measurements with superconducting qubits. A set of quantum gates is applied to the qubits for inducing an entangled state of the qubits before the qubits are exposed to a field of the environment, e.g., before they evolve under the influence of a magnetic field. A measurement of the resulting phase of the qubits can be used to determine the information on the field. The measurement is optimized by variational optimization of the set of quantum gates. The variational optimization maximizes the Quantum Fisher information of the measurement scheme in order to enhance the sensing beyond the standard quantum limit.

### SUMMARY OF THE DISCLOSURE

In a variational quantum algorithm, the choice of the cost function may effectively determine the measurement sequence as a result of the variational optimization. Commonly, the Quantum Fisher information is used as a maximization goal in the prior art, since it is considered to achieve the best possible estimation error using a fixed probe state, and the corresponding scheme may be numerically evaluated for currently available quantum hardware, such that most previous investigations focused on this approach.

The present disclosure solves the technological problem of determination of the statistical uncertainty associated with the state of a probe. However, the optimization of the precision via variational optimization of the Quantum Fisher information inherently results in a measurement which may be optimal only for a specific value of the phase. As a matter of fact, the dynamic range of the entangled quantum sensor may be reduced as compared to the quantum sensor with uncorrelated spins. Conversely, it can be beneficial for many high precision applications, e.g. in atomic clocks, to measure the physical quantity over an extended range of possible values. The present disclosure can improve existing approaches when the optimization goal of the prior art is abandoned in favor of a Bayesian approach, entanglement at the measurement stage can advantageously optimize the information gain per measurement for near term quantum hardware and may jointly optimize the sensitivity and the dynamic range of the method. The present disclosure improves the performance and functionality of the method itself by implementing specialized algorithms on a hybrid classical-quantum system, the hybrid classical-quantum system comprising a parametrized quantum circuit on the basis of a plurality of controllable quantum systems and further comprising a classical computation system, or other suitable combinations thereof. The resulting measurement scheme can be advantageously applied to atomic clocks but may equally be applied to other precision metrology tasks, such as magnetometry, even for a restricted set of quantum gates available on the measurement platform.

In a first aspect, the disclosure relates to a method of measuring a physical quantity, the method being implemented in a hybrid classical-quantum system. The hybrid classical-quantum system comprises a parametrized quantum circuit on the basis of a plurality of controllable quantum systems and further comprises a classical computation system. The method comprises the steps of initializing the plurality of controllable quantum systems in an initial state, and applying a set of preparation gates to the plurality of controllable quantum systems for preparing the plurality of controllable quantum systems in a non-classical state. The method further comprises evolving the non-classical state over a time period for obtaining an evolved state of the plurality of controllable quantum systems, and applying a set of decoding gates to the plurality of controllable quantum systems in the evolved state. The method further comprises performing a measurement of the plurality of controllable quantum systems, and determining a derived value of the physical quantity based on a mapping function between an outcome of the measurement and the physical quantity on the classical computation system. The set of preparation gates and the set of decoding gates each comprise non-linear quantum gates suitable for generating a non-classical state of the plurality of controllable quantum systems, and each comprise variational quantum gates characterized by variable actions onto controllable quantum systems of the plurality of controllable quantum systems. The variable actions are variationally optimized to find an extremal value of a cost function, wherein the cost function averages an estimation error of the derived value over a pre-defined expected prior distribution of the physical quantity.

Based on the variational optimization of the variable actions with the above cost function, the method may measure the physical quantity with an optimized information gain when the physical quantity follows the pre-defined expected prior distribution. Accordingly, the method may be applied to sensing a physical quantity over a pre-defined range of possible values, which may allow improving a signal to noise ratof the measurement in practice.

The physical quantity may be any parameter characterizing a field suitable to impart a state evolution onto the plurality of controllable quantum systems. For example, in an atomic clock on the basis of atoms, the physical quantity may be the frequency detuning of the oscillator, such as a microwave source or a laser, with respect to a transition frequency of the atoms. In other words, the physical quantity may be a parameter of an electromagnetic field suitable to act on the states of the controllable quantum systems, such as to induce a state evolution between states of the controllable quantum system or to impart a phase onto a superposition of states of the controllable quantum system. However, the physical quantity may also define an energy splitting in the controllable quantum system, e.g. a magnetic field defining a Zeeman splitting in a controllable quantum system, such as an atom, an electron, a superconducting oscillator, or the like.

The method is implemented on a hybrid classical-quantum system, which includes a parametrized quantum circuit comprising the plurality of controllable quantum systems as well as the classical computation system for controlling the parameterized quantum circuit, or for mapping the outcome to the derived value of the physical quantity.

The classical computation system may comprise a single processing unit or may comprise a plurality of processing units, which may be functionally connected. The processing units may comprise a microcontroller, an ASIC, a PLA (CPLA), an FPGA, or other processing device, including processing devices operating based on software, hardware, firmware, or a combination thereof. The processing devices can include an integrated memory, or communicate with an external memory, or both, and may further comprise interfaces for connecting to sensors, devices, appliances, integrated logic circuits, other controllers, or the like, wherein the interfaces may be configured to receive or send signals, such as electrical signals, optical signals, wireless signals, acoustic signals, or the like.

The classical computation system may comprise or control signal generators, power sources, and amplifiers for manipulating the controllable quantum systems using electromagnetic fields, such as laser pulses, microwave pulses, magnetic fields, electric fields, or the like. For example, the classical computation system may be functionally connected to optical components for selectively applying laser pulses to the plurality of controllable quantum systems. Further, the classical computation system may comprise an interface for receiving measurement information on the outcome from a sensor, such as a light sensor, a current sensor, a voltage sensor, or the like.

The classical computation system may also send control signals to elements of the parametrized quantum circuit, such as to initiate the method or to select the variable actions of the preparation or decoding gates.

The parametrized quantum circuit comprises the plurality of controllable quantum systems, which may act as probes of the physical quantity, and implements the sets of preparation gates and decoding gates with variable actions for acting on the controllable quantum systems.

The controllable quantum systems may be physical systems, in particular physical systems whose quantum state may be initialized, coherently manipulated, and read out.

Further, the implementation of the controllable quantum systems should allow for a quantum entanglement or the preparation of individual non-classical states of at least a subset of the plurality of controllable quantum systems via the preparation gates and the decoding gates.

The controllable quantum systems may comprise atoms, photons, nuclear or electronic spins, superconducting qubits, quantum dots, a combination thereof, or the like, whose quantum states may be initialized, coherently controlled and read out.

In some examples, the plurality of controllable quantum systems implement a corresponding plurality of qubits.

Qubits are physical two-level systems whose quantum mechanical state can be coherently controlled and substantially preserved between two basis states during the time of a computation, wherein in the following the basis states are being referred to as |0> and |1>.

As an example, a qubit may be implemented by encoding information in the spin state of an electron, e.g. in the electron being in an “up” state or a “down” state, but may also be encoded in a polarization state of a photon, in states of a (superconducting) oscillator, in energy levels of an atom, or the like.

Control operations on these qubits may be termed quantum gates. Quantum gates can coherently act on controllable quantum systems for inducing changes of the state of a single controllable quantum system, e.g. single-qubit gates, and for acting on multiple controllable quantum systems, e.g. multi-qubit gates to entangle the states of multiple qubits, and any combination thereof. For example, a single-qubit gate may induce a rotation of the spin state of an electron by a selectable value, e.g. π/2. A multi-qubit gate may coherently act on two or more qubits, such as a coherent CNOT operation on the state of two qubits. A plurality of quantum gates can be applied to the qubits of the quantum computer in parallel or in sequence for performing a computation. Finally, the state of the qubits may be measured repeatedly after applying a sequence of quantum gates to determine the probabilities for each possible outcome of the computation.

For example, atoms as controllable quantum systems may be trapped, e.g. as ionized atoms in an ion trap or trapped in an optical lattice. Two energy levels of each atom may implement a two-level system of a qubit. Transitions between the ground state and the excited state of the two-level system may be driven with optical pulses close to a transition frequency associated with the two energy levels and may be used to induce superposition states of each controllable quantum system.

However, the skilled person will appreciate that the controllable quantum systems are not limited to two-level systems, but may also implement multi-level quantum systems in some examples. For example, larger spin atoms, e.g. Dysprosium, Erbium, Holmium, or a Rydberg state manifold, may implement multi-level quantum systems, and non-linear operations may be used to generate non-classical states of the atoms for measuring a physical quantity, such as a frequency.

The set of preparation gates and the set of decoding gates each comprise non-linear quantum gates, e.g. multi-qubit gates, for entangling the quantum states of at least two of the plurality of controllable quantum systems or for squeezing individual states of the plurality of controllable quantum states. For example, the states of different atoms acting as controllable quantum systems in the method may be entangled via a non-linear quantum gate, such as a one-axis-twisting operation acting on a subset or all of the atoms, e.g. implemented via the Wilmer-Sørensen interaction. Hence, the resulting state may generally feature entanglement between the states of the controllable quantum systems. Additionally or alternatively, the controllable quantum states may comprise atoms with a large magnetic moment, e.g. Dysprosium, Erbium, Holmium, or a Rydberg state manifold, and the set of preparation gates may prepare the controllable quantum systems in individually non-classical states, e.g. squeezed spin states. Accordingly, the non-linear quantum gates may not result in entanglement between different controllable quantum systems in some examples.

Further, the set of preparation gates and the set of decoding gates each comprise variational quantum gates parametrized by variable actions. For example, the variational quantum gates may comprise single qubit gates, and the variable action may be a variable angle of rotation between the states of the qubit.

In some examples, the set of preparation gates and the set of decoding gates each comprise layers of quantum gates, with each layer comprising at least one non-linear quantum gate and at least one variational quantum gate.

Each layer may comprise a plurality of quantum gates, which act, at least collectively, on all of the controllable quantum systems. Each layer of the set of preparation gates or of the set of decoding gates may have the same structure, e.g. the same sequence and types of quantum gates. For example, each layer may comprise a sequence of control operations, e.g. laser pulses, microwave pulses, a combination thereof, or the like, while the action of the control operations, e.g. the amplitude or pulse width, may differ according to the respective variable actions associated with each layer. Each layer may be associated with at least one variable action, such as 2 or 3 or more variable actions, which may differ between the layers of the set of preparation/decoding gates. Further, the number of layers in the set of preparation gates and in the set of decoding gates may be different. The skilled person will appreciate that the at least one non-linear quantum gate may be a non-linear variational quantum gate parametrized by a variable action, and may therefore combine the at least one non-linear quantum gate and the at least one variational quantum gate in one controlled quantum operation.

The combination of the set of preparation gates and the set of decoding gates may be considered to form a parametrized quantum circuit. Based on the selection of the variable actions for the set of preparation gates and the set of decoding gates, the non-classical state and the effective measurement basis may be tuned for an optimized measurement.

In between the application of the set of preparation gates and the set of decoding gates, the non-classical state evolves for a certain time period. Generally, the evolution may be coherent, and may or may not comprise subjecting the controllable quantum systems to a field associated with the physical quantity, such as a magnetic field, depending on the measurement scheme.

In some examples, the physical quantity is an oscillating frequency of electromagnetic radiation interacting with the plurality of controllable quantum systems prior to and after step C).

For example, the method may implement a generalized Ramsey interferometer for sensing the frequency of electromagnetic radiation. The states of the plurality of controllable quantum systems may be rotated by a rotation angle of substantially π/2 using the electromagnetic radiation before and after a free evolution period, in which the non-classical state evolves over the time period. For example, pulses of the electromagnetic radiation may be applied to the controllable quantum systems at specific times in a measurement sequence. The first pulse may imprint a phase of the electromagnetic radiation onto the plurality of controllable quantum systems by creating a superposition state. The second pulse may then recover a difference of the phase between the electromagnetic radiation and a phase of the plurality of controllable quantum systems accumulated over the time period. Depending on a frequency detuning of the electromagnetic radiation and of a transition frequency between the states of the plurality of controllable quantum systems, the outcome may feature a different proportion of the plurality of controllable quantum system in the respective excited or ground states and may be used to infer the value of the frequency detuning.

In some examples, the derived value is a phase originating from a difference in the oscillating frequency and a resonant frequency of the plurality of controllable quantum systems.

The phase may be proportional to the difference in the oscillating frequency and a resonant frequency as well as the time period of coherent evolution, and the method may select a time period, such that the standard deviation of the phase corresponds substantially to a standard deviation of the pre-defined expected prior distribution.

The skilled person will appreciate that the aforementioned pulses of the generalized Ramsey interferometer need not induce rotation angles of π/2, but may induce different rotation angles, e.g. at the expense of measurement contrast. For example, the rotation angle may be angle greater than π/4 or greater than π/3, and smaller than 3π/4 or smaller than 2 π/3. In some examples, the pulses of the generalized Ramsey interferometer may be applied before or after applying the preparation and decoding gates. In some examples, the pulses of the generalized Ramsey interferometer are implemented as part of the preparation and decoding gates. For example, control operations forming part of the preparation and decoding gates may be based on driving a state evolution of the plurality of controllable quantum systems with the electromagnetic radiation, such as to imprint a phase of the electromagnetic radiation on the plurality of controllable quantum systems.

However, the controllable quantum systems may in principle be subjected to the action of any quantum operator which affects the quantum states of the plurality of controllable quantum systems during the time period, without implementing a Ramsey interferometer. Rather, the method may measure a state evolution of the plurality of controllable quantum systems caused by the quantum operator during the time period. The final outcome may then be proportional to a value of the physical quantity which parametrizes the quantum operator, such as the strength of a magnetic field inducing a level splitting in the controllable quantum systems.

The set of preparation gates and the set of decoding gates may tailor the non-classical state evolving during the time period and the details of the measurement to reduce a statistical uncertainty of the measurement. The action (e.g. controlled state evolution) of the set of preparation gates and of the set of decoding gates on the controllable quantum systems may be determined by the variable actions.

The variable actions employed in the method can be obtained through a variational optimization of the variational quantum gates, which minimizes a cost function, wherein the cost function averages an estimation error of the derived value over a pre-defined expected prior distribution of the physical quantity. In other words, to determine the variable actions, the average estimation error of the method may be weighted according to a pre-defined expected prior distribution of the cost function.

The variable actions may be systematically adjusted to minimize the weighted average estimation error in a variational optimization. The variational optimization may comprise an estimation of a gradient or energy landscape of the cost function with respect to the variable actions. For example, using the parameter shift rule, the measurement method may be performed repeatedly with shifted variable actions to determine partial derivatives of the outcome with respect to the variable actions. A classical computation system may calculate or estimate a corresponding gradient of the cost function based on the partial derivatives with respect to the variable actions.

The variable actions may be updated based on the gradient, e.g. using gradient descent techniques, such as momentum based gradient descent, Nesterov accelerated gradient descent, an AdaGrad based algorithm, a combination thereof, or the like.

In some examples, the gradient is estimated based on a local evaluation of the energy landscape of the cost function, such as by using constrained optimization by linear approximation algorithm, wherein the method may sample the cost function for different sets of variable actions to estimate the energy landscape of the cost function.

In some examples, the variational optimization comprises a derivative-free optimization algorithm. For example, the energy landscape of the cost function may be sampled in a given search domain, e.g. using the Dividing Rectangles algorithm, and the search domain may be refined based on the obtained samples of the cost function to identify variable actions associated with a minimized cost function.

The variational optimization may be performed utilizing Gauss-Hermite quadrature integration of the mean square error over selected values of the physical quantity, such as to improve a speed of the optimization. In some examples, the mean square error is a symmetric function of the derived value around zero, and the variational optimization may be performed only for negative or positive values of the physical quantity.

The skilled person will appreciate that different variational optimization algorithms may be combined to arrive at a set of variationally optimized variable actions. Further, the skilled person will appreciate that the cost function described herein is a cost function which is associated with a minimal value when the average estimation error weighted according to the pre-defined expected prior distribution is minimal. For such a cost function, the variational optimization should minimize the cost parameter. However, in some examples, the cost function may feature a maximal value, when the average estimation error weighted according to the pre-defined expected prior distribution is minimal, such that the variational optimization should maximize the cost parameter in order to optimize an information gain of the method. Accordingly, the extremal value may be a minimum or a maximum of the cost function depending on whether the cost function is proportional or inversely proportional to the average estimation error weighted according to the pre-defined expected prior distribution.

After the variational optimization, the variable actions may feature values imprinted by the choice of the cost function, and may differ from variable actions obtained through variational optimization using a different cost function. Accordingly, the cost function may determine both the non-classical state as well as the action of the decoding gates on the evolved state. The cost function may therefore characterize the operation of the parametrized quantum circuit in the method.

The variable actions obtained through this variational optimization may in the following be used to implement the method.

The skilled person will appreciate that the variable actions may determine an optimized measurement strategy for a given structure of a parametrized quantum circuit, e.g. a structure consisting of a given set of preparation gates and decoding gates as well as a given plurality of controllable quantum systems. Hence, the variable actions obtained through variational optimization in one measurement apparatus or obtained through a numerical simulation of the measurement apparatus may be used in a different measurement apparatus, e.g. having the same or a similar structure of the sets of preparation and decoding gates, to implement the method. Accordingly, the method according to the first aspect may not comprise variationally optimizing the variable actions in the parametrized quantum circuit used for measuring the physical quantity. Rather, the parametrized quantum circuit may be implemented with variationally optimized variable actions for the same or a similar parametrized quantum circuit structure.

In some examples, the method may comprise selecting a set of variable actions optimized for a pre-defined expected prior distribution from a database.

For example, the method may determine an uncertainty of the physical quantity from a previous measurement, and may select the set of variable actions optimized for a corresponding pre-defined expected prior distribution. For example, the method may select variable actions optimized for a pre-defined expected prior distribution centered around a most likely value of the physical quantity or a pre-defined expected prior distribution associated with a stochastic width (e.g. standard deviation) corresponding to the uncertainty of the physical quantity.

Hence, the hybrid classical-quantum system may comprise or be connected to a database comprising a plurality of sets of variable actions previously variationally optimized for different pre-defined expected prior distribution based on the cost function, and a suitable set of variable actions may be selected based on the uncertainty on the physical quantity.

The variable actions may be implemented in a measurement system, e.g. by tuning variational parameters parametrizing the action of quantum gates, such as a current or pulse amplitude, to implement the variable actions.

In some examples, the cost function is mathematically equivalent to C=∫dϕϵ(ϕ) P(ϕ), wherein ϕ is the physical quantity, ϵ(ϕ) is the average estimation error for a given value of the physical quantity, and NO is the pre-defined expected prior distribution of the physical quantity.

For example, the cost function may be a sum of average estimation errors of the measurement for different values of the physical quantity, and the average estimation error of each summand may be weighted according to the pre-defined expected prior distribution of the physical quantity, e.g. according to C˜Σ_{ϵ} (ϕ) P(ϕ).

In some examples, the estimation error ϵ(ϕ) is the average mean square error of the derived value with respect to an actual value of the physical quantity.

Hence, the variational optimization may optimize a phase estimation accuracy, which may be defined as the mean square error ϵ(ϕ) relative to the actual phase averaged with respect to a the prior distribution P(ϕ) over a finite dynamic range δϕ of the measurement which may be introduced through the stochastic width (e.g. standard deviation) of the prior distribution P(ϕ).

In some examples, ϵ(ϕ) is mathematically equivalent to ϵ(ϕ)=∫dx [ϕ−ϕₑₛₜ(x)]² p(x|ϕ), wherein x is the outcome, ϕₑₛₜ(x) is the mapping function mapping the outcome x to the derived value of the physical quantity, ϕ is the actual value of the physical quantity, and p(x|ϕ) is the conditional probability of measuring the outcome x when the actual value of the physical quantity is ϕ.

For example, the measurement may obtain a series of n outcomes Xᵢ and the squared estimation error may be determined according to

$$ϵ ( ϕ ) ∼ \frac{1}{n} {\sum }_{{X}_{i}} {[ ϕ - {ϕ}_{est} ( {X}_{i} ) ]}^{2} .$$

In some examples, the pre-defined expected prior distribution approximates or is mathematically equivalent to a Normal distribution centered around an expected mean value of the physical quantity or the derived value.

The prior distribution P(ϕ) may reflect the statistical properties of the unknown phase ϕ and may be, in general, sensor and task dependent. As a result of the variationally optimized variable actions, the form of the pre-defined expected prior distribution may determine the dynamic range δϕ over which the method performs optimally. The stochastic width of the pre-defined expected prior distribution may correspond to an expected width of a stochastic distribution of the physical value and may depend on the time period selected for the measurement, e.g. as in the case of a frequency measurement with a generalized Ramsey interferometer as discussed above. The mapping function may be selected, such that an expected mean value of the derived value is zero, e.g. zero phase, and the normal distribution may accordingly be a Normal distribution centered around zero in some examples.

In some examples, the derived value is a periodic function with respect to changes of the physical quantity, and the pre-defined expected prior distribution is associated with a standard deviation δϕ smaller than a period of the periodic function.

For example, the standard deviation δϕ may be smaller than 15% of the period of the periodic function.

The physical quantity may be a frequency or frequency detuning giving rise to a periodic phase in the evolution of the plurality of quantum systems, as discussed above. The periodic phase of the plurality of quantum systems may be projected onto a periodic outcome by the measurement, and the periodicity may be reflected by the derived value of the outcome. For example, in the case of a phase as the derived value with 2π periodicity, the standard deviation δϕ of the pre-defined expected prior distribution may be smaller than 1, such as to obtain an optimized method for a measurement regime with comparatively low ambiguity of the derived value.

In some examples, the derived value is a periodic function with respect to changes of the physical quantity, and the pre-defined expected prior distribution is associated with a standard deviation δϕ greater than 1/N of the period of the periodic function, wherein N is the number of controllable quantum systems.

For example, when the derived value is a phase with a 2π periodicity, the standard deviation δϕ of the pre-defined expected prior distribution may be greater than 0.1 or greater than 0.01 for 64 or 640 controllable quantum systems, respectively, such as to optimize information gain per measurement.

In principle, the pre-defined expected prior distribution may be any distribution, such as a flat distribution over a period of a periodic mapping function of the outcome. However, by selecting a suitable distribution reflecting the statistical properties of the physical quantity, e.g. a normal distribution, and which is associated with a standard deviation δϕ, which is a fraction of the period, e.g. between 1/N or 1% of the period and 15% of the period, the method may be optimized for a measurement regime in which the information gain per measurement may be optimized.

In some examples, the plurality of controllable quantum systems implement a plurality of two-level-systems, wherein the mapping function maps a difference between the number of controllable quantum systems in an excited state and in a ground state of the plurality of two-level-systems to the derived value of the physical quantity.

For example, the measurement may project the states of the controllable quantum systems onto the basis states of the two-level-systems, and may measure the state of the controllable quantum systems, e.g. by measuring a luminosity of the controllable quantum systems in an optical measurement sensitive to a state population in the excited state or the ground state. The measurement may resolve the state of each controllable quantum system, or may determine a total number of controllable quantum systems in a pre-defined state, such as via state selective fluorescence.

The mapping function maps the outcome onto a derived value of the physical quantity. The mapping function may be considered to estimate a most probable derived value given a certain measurement outcome.

In principle, the mapping function may be an arbitrary function. However, in some examples, a linear function may be selected as the mapping function.

In some examples, the mapping function is mathematically equivalent to a linear function of the difference at least over a standard deviation of the pre-defined expected prior distribution.

For example, the mapping function may map an outcome m to an estimated derived value ϕₑₛₜ via the function ϕₑₛₜ(m)=am+b, with a and b being in principle free parameters.

The parameters a and b may be optimized alongside the variable actions as part of a variational optimization. However, a and b may also be analytically or numerically selected to optimize the measurement for the pre-defined expected prior distribution, e.g. for a certain prior distribution associated with a certain standard deviation, and may be fixed before the variable actions are variationally optimized. Moreover, a and b may also be analytically or numerically selected during each iteration of variationally optimizing the variable actions, e.g. may be analytically or numerically selected to minimize the cost function for a given set of measurement outcomes.

For example, one may obtain the mean of the measurement outcomes (m)_{ϕ}, =Σₘ m p (m|ϕ) given a phase ϕ in an experiment or via a theoretical simulation of the parametrized quantum circuit. Based on the mean of the measurement outcomes one may choose the parameter a to represent the inverse slope of [symbol] m)_{ϕ}, i.e., a=(δ(m [symbol] _{ϕ}/δϕ)⁻¹ and b=−(m)_{ϕ} at =0. The choice of these parameters may ensure that Σₘ ϕₑₛₜ(m)P(m|ϕ)=ϕ, at ϕ=0.

Further, one may obtain the mean of the measurement outcomes and the mean of the squared measurement outcomes (m²)_{ϕ}=Σₘm²p(m|ϕ) given an actual value ϕ, in an experiment or via a theoretical simulation of the circuits. Based on this, one may obtain the optimal parameters a=Cov(ϕ,m)/Var(m) and b=−a∫dϕ(m)_{ϕ}P(ϕ) given a prior phase distribution P(ϕ). The resulting mapping function may minimize the BMSE over all linear estimators, given a realization of the preparation and decoding circuits. Here Cov(ϕ,m)=∫d ϕϕ(m)_{ϕ}P (ϕ)−[∫d ϕϕP(ϕ)][∫d ϕ(m)_{ϕ}P (·)] is an expression for the covariance between the measurement and the actual phase averaged over the prior distribution and Var(m)=∫dϕ[(m)²_{ϕ}−(m)²_{ϕ}]P(ϕ) is an expression for the measurement variance averaged over the prior distribution.

However, the skilled person will appreciate that these examples should not be considered to limit the method to linear mapping functions. For example, one may also choose the mapping function to be the inverse function of (m)_{ϕ}, e.g. based on measurement outcomes or theoretical simulations of (m)_{ϕ}for multiple values of the actual value ϕ, so that ϕₑₛₜ((m)_{ϕ})=ϕ.

Further, the mapping function may in general be a minimum mean squared error estimator. For example, one may obtain the conditional probability distribution p(m|ϕ) in an experiment or via a theoretical simulation of the circuits. Based on conditional probability distribution one may calculate the probability p(m)=∫dϕp (m|ϕ) to obtain the measurement outcome m given the prior phase distribution P(ϕ). One may further calculate the posterior probability distribution p(ϕ|m)=p(m|ϕ)P(ϕ)/p(m) using Bayes theorem. One may choose the minimum mean squared error estimator ϕₑₛₜ(m)=∫d (ϕ)(ϕ)p(ϕ|m)P(ϕ) corresponding to expectation value of the phase conditional to the measurement outcome m. The minimum mean squared error estimator may minimize the Bayes mean squared error over all possible estimation functions, given a realization of the preparation and decoding circuits.

Preferably, the mapping function is strictly monotonic at least over a finite dynamic range of the interferometer, such as over one or multiple standard deviations of the pre-defined expected prior distribution.

In some examples, the method comprises applying an additional pulse, such as a πt-pulse, during the coherent evolution during the time period. The additional pulse may reduce dephasing effects.

In a second aspect, the disclosure relates to a clock. The clock comprises an oscillator for generating electromagnetic radiation associated with an oscillator frequency, a plurality of controllable quantum systems implementing a corresponding plurality of two-level systems, wherein an energy difference of the two-level systems corresponds to a target clock frequency of the clock, and a controller. The controller is configured to initialize the plurality of controllable quantum systems in an initial state, and apply a set of preparation gates to the plurality of controllable quantum systems. The controller is further configured to permit an evolution of the plurality of controllable quantum systems over a time period, and apply a set of decoding gates to the plurality of controllable quantum systems. The controller is further configured to determine a measurement outcome of the plurality of controllable quantum systems, and determine a feedback onto the oscillator based on a mapping function between the measurement outcome and a derived frequency difference between the oscillator frequency and the target clock frequency associated with the plurality of two-level systems. Before and after the evolution of the plurality of controllable quantum systems over the time period, the controller drives a state rotation of each of the plurality of controllable quantum systems using the electromagnetic radiation of the oscillator to implement a Ramsey interferometer. The set of preparation gates and the set of decoding gates each comprise non-linear quantum gates suitable for generating a non-classical state of the plurality of controllable quantum systems and each comprise variational quantum gates characterized by variable actions onto at least one of the plurality of controllable quantum systems. Values of the variable actions are the result of a variational optimization of the variable actions based on a cost function, wherein the cost function averages an estimation error of the derived value over a pre-defined expected prior distribution of the physical quantity.

The skilled person will appreciate, that although reference is made to a controller, a plurality of control units may be configured to implement the controller, e.g. as a control system comprising a plurality of control units. The controller may comprise a classical computation system, and the classical computation system may control the action of the control units for controlling the oscillator frequency of the clock through the feedback onto the oscillator. The feedback may adjust an operating parameter of the oscillator, such that the oscillator frequency approaches the clock frequency.

In some examples, the plurality of controllable quantum systems are implemented in a corresponding plurality of atoms.

The atoms may implement the two-level systems in a radiative transition between a ground state and an excited state. Transitions between the ground state and the excited state may be implemented by applying pulses of electromagnetic radiation to the atoms, wherein a frequency of the electromagnetic radiation may correspond to an energy splitting between the ground state and the excited state. The energy splitting in atoms may be well defined, such that the transition between the ground state and the excited state may act as a stable frequency reference of the clock. Readout of the two-level systems may include exciting a transition of the ground state or the excited state to a third state of the atom, e.g. via state dependent fluorescence.

In some examples, the controller drives a global rotation of the states of the plurality of controllable quantum systems by an angle of substantially π/2 to implement the Ramsey interferometer.

In some examples, the pre-defined expected prior distribution corresponds to an expected statistical distribution of the actual value after the evolution over the time period.

For example, the width of the pre-defined expected prior distribution may be a function of a product of a noise bandwidth b of the oscillator and of the time period T, e.g. δϕ˜(bT)^{a/2}, with a being an integer value, e.g. 1, 2, or 3.

In some examples, the set of preparation gates and the set of decoding gates each implement global rotations of the states of the plurality of controllable quantum systems approximating the operator R_{μ} (θ₁)=exp(−iθ₁J_{μ}) and a variational non-linear quantum gate selected from the group of a generalized exchange coupling approximating the operator G (t)=exp[−iHt], with H=Σ_{k,l=1}^{N}jₖᵢσₖ^{μ}σₗ^{ν}+ΣₖΔₖ σₖ^{P} or H=Σ_{k,l=1}^{N}j_{k,l}σₖ^{μ}σₗ^{μ}+ΣₖΔₖσₖν and with j_{k,l} representing a generalized coupling strength between controllable quantum systems k,l,a one-axis twisting operation of the states of the plurality of controllable quantum systems approximating the operator Tᵤ(θ₂)=exp(−iθ₂Jᵤ²), and a Rydberg dressing operation approximating the unitary operator

$${D}_{υ} ( {θ}_{2} ) = exp [ - i {θ}_{2} ( \frac{{H}_{υ}^{D}}{{V}_{0}} ) ] ,$$

with Hᵤ^{D} being the effective interaction Hamiltonian and V_{ϕ}corresponding to the interaction strength, with μ, ν, ρ specifying an axis of rotation about respective variable angles θ₁, θ₂, the variable angles θ₁, θ₂ and j_{k,l} or a function thereof being the respective variable actions.

The operator Jᵤ in Tᵤ(θ₂) may be given by j_{x,y,z}=½ Σₖ₌₁^{N}σₖ^{x,y,z}, wherein N is the number of controllable quantum systems, and σₖ^{x,y,z} are general spin operators, such as the Pauli operators. The inventors found that an optimized measurement with a statistical uncertainty below the standard quantum limit may be implemented with global rotations of the plurality of controllable quantum systems as well as infinite-range one axis-twisting of the plurality of controllable quantum systems about variable twisting angles. However, the method may be similarly implemented with different entangling gates as non-linear quantum gates, such as Rydberg dressing operations of states in optical lattices of ultracold atoms. As the non-linear gates are variational gates, the gate length of the set of preparation and decoding gates may be reduced, which may facilitate implementation or improve accuracy of the cock. The skilled person will appreciate that the coupling strengths of the operators above may in general also be time dependent, such as time dependent couplings j_{k,l}(t) and Δₖ (t) in the case of the generalized exchange coupling.

In some examples, the set of preparation gates and the set of decoding gates each comprise a number of n_{En} and n_{De} layers of quantum gates, respectively, wherein n_{En} and n_{De} are natural/positive integer numbers, and wherein each layer comprises at least one non-linear quantum gate and is parametrized by at least one variable action.

Each layer may comprise a plurality of quantum gates, which act, at least collectively, on all of the controllable quantum systems. Each layer of the set of preparation gates or of the set of decoding gates may have the same structure, e.g. the same sequence and types of quantum gates. In some examples, each layer comprises at least one entangling quantum gate as the non-linear quantum gate.

As an example, each layer may comprise a global rotation of the states of the plurality of controllable quantum systems parametrized by a rotation angle and two entangling gates, e.g. a one axis-twisting operation or a Rydberg dressing operation of the plurality of controllable quantum systems, parametrized by respective variable actions (e.g. twisting angles). In this example, each layer may feature three variable actions.

However, the layers may also feature individual rotations of the states of each of the plurality of controllable quantum systems, wherein each individual rotation may be parametrized by a respective rotation angle, and at least one entangling gate, such as a CNOT quantum gate, may be applied to the states of the plurality of controllable quantum systems.

The number of layers in the set of preparation gates and in the set of decoding gates may be different.

In some examples, n_{En} is equal to or smaller than n_{De}.

For example, the set of preparation gates may have 1 or 2 layers of preparation gates, and the set of decoding gates may have 3 or 5 layers of decoding gates.

In a third aspect, the disclosure relates to a method of optimizing a measurement of a physical quantity with a hybrid classical-quantum system comprising a plurality of controllable quantum systems. The method comprises the step of initializing a number of variational parameters, the variational parameters parametrizing variable actions of variational quantum gates for acting onto the plurality of controllable quantum systems. The method comprises the step of repeatedly implementing a measurement sequence of known values of the physical quantity using the plurality of controllable quantum systems. The measurement sequence has the steps of initializing the plurality of controllable quantum systems in an initial state, and applying a set of preparation gates to the plurality of controllable quantum systems for preparing the plurality of controllable quantum systems in a non-classical state. The measurement sequence further comprises evolving the non-classical state for obtaining an evolved state of the plurality of controllable quantum systems evolved according to a select one of the known values, and applying a set of decoding gates to the plurality of controllable quantum systems in the evolved state. The measurement sequence further comprises determining a measurement outcome of the evolved state for the select one of the known values. The set of preparation gates and the set of decoding gates each comprise non-linear quantum gates suitable for generating a non-classical state of the plurality of controllable quantum systems and each comprise variational quantum gates characterized by variable actions onto controllable quantum systems of the plurality of controllable quantum systems. The method further comprises mapping each of the measurement outcomes to a corresponding derived value of the physical quantity according to a mapping function, and determining a cost parameter according to a cost function which averages an estimation error between the derived values and the corresponding known values over a pre-defined expected prior distribution of the physical quantity. The method further comprises selecting updated variational parameters to reduce the cost parameter, and iteratively repeating steps b)-e) towards variational parameters associated with a minimized cost parameter.

In some examples, selecting updated variational parameters to reduce the cost parameter comprises estimating an energy landscape or a gradient of the cost function with respect to the variational parameters.

In some examples, estimating the energy landscape or the gradient comprises repeatedly implementing the sequence b)-e) with shifted variational parameters, the shifted variational parameters comprising a subset of the variational parameters being shifted with respect to a current set of variational parameters.

### BRIEF DESCRIPTION OF THE DRAWINGS

The following detailed description will best be understood with reference to the drawings, wherein:

FIG. 1 shows a schematic example of a measurement system for measuring a physical quantity;

FIG. 2 illustrates an example of a method of measuring a physical quantity;

FIG. 3 illustrates a flow diagram of a method of variationally optimizing a set of variational parameters according to an example;

FIGS. 4A, 4B illustrate another example of a measurement system for measuring a physical quantity;

FIG. 5 illustrates the result of calculations of the performance of a measurement sequence based on a plurality of controllable quantum systems according to an example;

FIG. 6 shows an example visualization of quantum states for the measurement sequence discussed in connection with the example of FIG. 5; and

FIG. 7 illustrates an example of a clock based on a plurality of controllable quantum systems.

### DETAILED DESCRIPTION

The disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principal features described herein. The examples used in the following description are intended to facilitate an understanding of the ways in which the disclosure can be implemented and practiced. Accordingly, these examples should not be construed as limiting the scope of the claims.

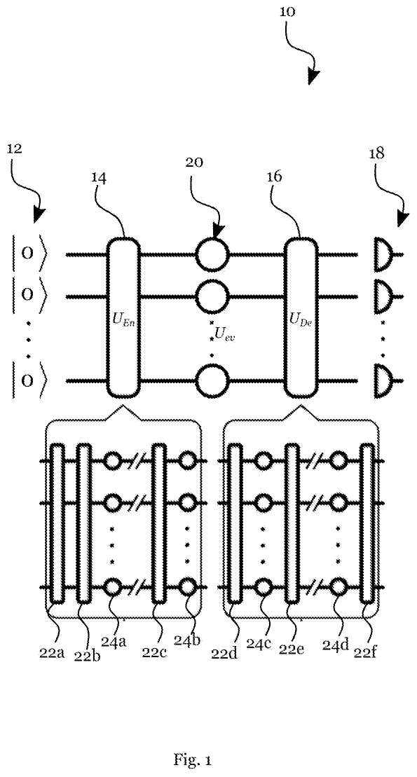

FIG. 1 shows a schematic example of a measurement system 10 for measuring a physical quantity, the system 10 being illustrated by a flow of a measurement sequence progressing in time from left to right. The system 10 comprises a plurality of controllable quantum systems 12, wherein individual controllable quantum systems 12 are represented by initial quantum states 10>. In the following, reference will be made to two-level systems having basis states 10> and 11>as controllable quantum systems 12, which may be implemented as nuclear or electronic spins, or electronic levels of atoms, although the disclosure is in general not limited to such an implementation.

The measurement system 10 further implements a parameterized quantum circuit including a set of preparation gates 14 and a set of decoding gates 16 acting on the state of the plurality of controllable quantum systems 12. In addition, the system 10 comprises a detection system 18 for measuring the state of the plurality of controllable quantum systems 12, which may comprise a plurality of detectors for measuring the state of each of the plurality of controllable quantum systems 12, as shown in FIG. 1.

As illustrated in FIG. 1, the set of preparation gates 14 may prepare the plurality of controllable quantum systems 12 according to a unitary operation U_{En} and the set of decoding gates 16 may decode the evolved state before the measurement according to a unitary operation U_{De}. Each of the set of preparation gates 14 and the set of decoding gates 16 may be composed of a plurality of non-linear quantum gates 22a-f and may further comprise rotations 24a-d of the states of individual quantum systems 12 (in following also called single qubit operations).

The plurality of non-linear quantum gates 22a-f may drive a coherent evolution of the plurality of controllable quantum systems 12, which may be suitable to induce entanglement between at least two and preferably all of the controllable quantum systems 12 (e.g. multi-qubit gates). The plurality of non-linear quantum gates 22a-f are illustrated as quantum gates acting on all states of the controllable quantum systems 12, but may also be composed of a plurality of quantum gates, which may jointly act on all of the controllable quantum systems 12, such as a plurality of finite range interactions, e.g. acting on spatially neighboring controllable quantum systems.

The rotations 24a-d of the states of the controllable quantum systems 12 may be individual rotations or may be global rotations of the states of the controllable quantum systems 12 by a pre-determined angle.

The measurement system 10 may be configured to initialize the plurality of controllable quantum systems 12 in an initial state, and may be configured to prepare the plurality of controllable quantum systems 12 in a non-classical state through the action of the set of preparation gates 14 at the beginning of the measurement sequence.

The measurement system 10 may be configured to evolve the non-classical state according to a Unitary evolution Uₑᵥ over a interrogation period 20 for obtaining an evolved state of the plurality of controllable quantum systems 12. During the interrogation period 20, a signal to be measured may be encoded into the non-classical state of the plurality of controllable quantum systems 12. For example, the signal may be encoded by a coherent free evolution of the non-classical state or through the action of an electromagnetic field acting on the plurality of controllable quantum systems 12.

At the end of the interrogation period 20, the system 10 may be configured to apply the set of decoding gates 16 to the evolved state of the plurality of controllable quantum systems 12, and the measurement system 10 may be configured to record a resulting outcome by measuring the plurality of controllable quantum systems 12. The measurement system 10 may be configured to perform a projective von Neumann measurement of the plurality of controllable quantum systems 12, e.g. onto the basis states |0> and |1> of a two-level system. For example, the outcome may be a sequence of measurement results for the states of the plurality of controllable quantum systems 12, may be a number of controllable quantum systems 12 measured in the excited state, e.g. |1>, or in the ground state, e.g. |0>, or a difference between the number of controllable quantum systems 12 in an excited state and in a ground state.

A classical computation system (not shown) of the measurement system 10 may receive the measurement outcome and may be configured to compute a derived value of the physical quantity via a mapping function.

Accordingly, the system 10 may be configured to quantitatively determine the physical quantity based on the Unitary evolution Uₑᵥ imparted onto the plurality of controllable quantum systems.

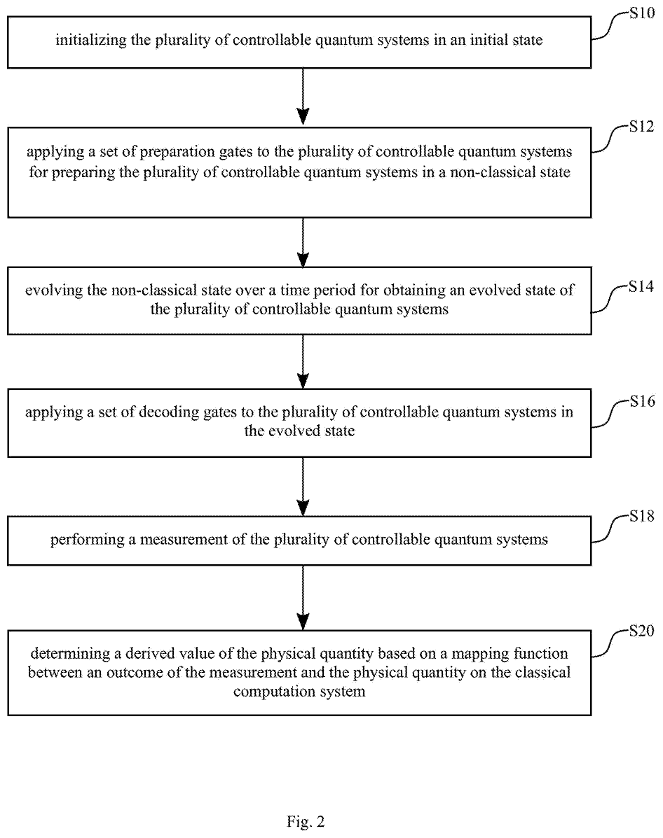

FIG. 2 illustrates a flowchart of a method of measuring a physical quantity according to an example, which may be implemented in the measurement system 10 of FIG. 1. The method comprises initializing the plurality of controllable quantum systems 12 in an initial state (S10), and applying a set of preparation gates 14 to the plurality of controllable quantum systems 12 for preparing the plurality of controllable quantum systems 12 in a non-classical state (S12). The method further comprises evolving the non-classical state over a time period 20 for obtaining an evolved state of the plurality of controllable quantum systems 12 (S14), and applying a set of decoding gates 16 to the plurality of controllable quantum systems 12 in the evolved state (S16). The method further comprises performing a measurement of the plurality of controllable quantum systems 12 (S18), and determining a derived value of the physical quantity based on a mapping function between an outcome of the measurement and the physical quantity on the classical computation system (S20).

Preferably, the set of preparation gates 14 and the set of decoding gates 16 are selected to jointly optimize sensitivity and dynamic range of measuring physical quantity. In principle, the set of preparation gates 14 and the set of decoding gates 16 may be tuned for implementing an optimal quantum interferometer (OQI), as theoretically described by Macieszczak et al. (New. J. Phys. 16, 113002). However, in practice it may not be feasible to reproduce a given Unitary operation, such as the operations needed for the OQI, with a restricted set and number of quantum operations and for comparatively large numbers of controllable quantum systems.

Instead, the inventors propose to construct the set of preparation gates 14 and the set of decoding gates 16 from native resources available in the measurement system 10 for the plurality of controllable quantum systems 12, and to variationally optimize the set of preparation gates 14 and the set of decoding gates 16 on the basis of a suitable cost function.

For example, the action of quantum gates 22a-24d of the set of preparation gates 14 or the set of decoding gates 16 may be parameterized by variable actions, such as a variable rotation angle of one of the rotations 24a-d of the states of the quantum systems 12. The variable actions may then be optimized in a variational optimization, wherein an optimization strategy may be represented by a cost function attributing a score to the measurement.

To jointly optimize sensitivity and dynamic range of measuring physical quantity, the inventors propose to optimize the phase estimation accuracy of the measurement based on a corresponding cost function. A finite dynamic range δϕ may be introduced in a Bayesian approach through the stochastic width of a prior distribution P(ϕ) in the cost function.

The cost function may average an estimation error of the derived value over a pre-defined expected prior distribution of the physical quantity, e.g. according to

C=∫dϕϵ(ϕ)P(ϕ), (1)

wherein (ϕ) is the physical quantity, ϵ(ϕ) is the average estimation error for a given value of the physical quantity, and P(ϕ) is the pre-defined expected prior distribution of the physical quantity.

The estimation error ϵ(ϕ) may be the average mean square error of the derived value with respect to an actual value of the physical quantity, e.g. according to

ϵ(ϕ)=∫dx[ϕ−ϕₑₛₜ(x)]²p(x|ϕ), (2)

wherein x is the outcome, ϕₑₛₜ(x) is the mapping function mapping the outcome x to the derived value of the physical quantity, ϕ is the actual value of the physical quantity, and p(x|ϕ) is the conditional probability of measuring the outcome x when the actual value of the physical quantity is ϕ.

The variable actions of the set of preparation gates 14 and the set of decoding gates 16 may then be optimized towards a minimal cost C.

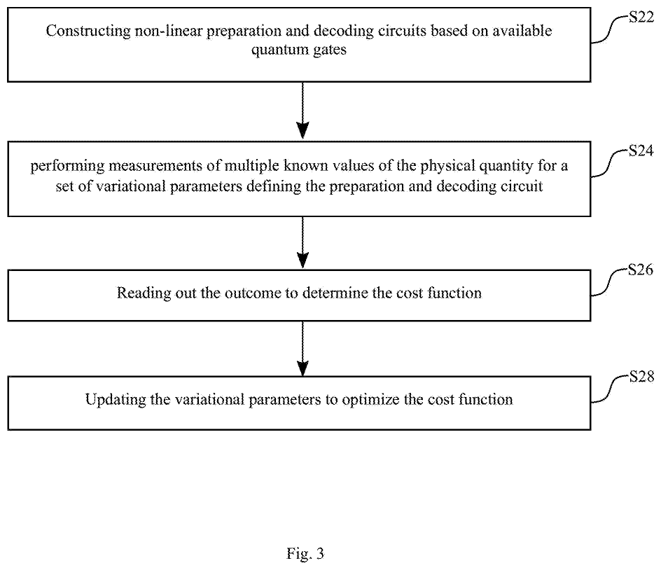

FIG. 3 illustrates a flowchart of a method for variationally optimizing the variable actions according to an example. The method comprises constructing non-linear preparation and decoding circuits based on available quantum gates (S22), and performing measurements of multiple known values of the physical quantity for a set of variational parameters defining the preparation and decoding circuit (S24). The method then comprises reading out the outcome to determine the cost function (S26), and updating the variational parameters to optimize the cost function (S28).

The variational parameters parametrize variable actions of variational quantum gates for acting onto the plurality of controllable quantum systems 12. For example, a variational parameter may be a pulse length or a pulse amplitude of a laser pulse for driving a rotation of one of the controllable quantum systems 12, and a corresponding rotation angle may be a variable action corresponding to the variational parameter.

The method may repeatedly perform steps S24 to S28 until the value of the cost function for the variational parameters is at or close to a global minimum of the cost function. The skilled person will appreciate that the variational parameters may in principle be numerically optimized, e.g. by calculating or simulating the action of the set of preparation gates 14 and the set of decoding gates 16 on the plurality of controllable quantum systems 12. Additionally or alternatively, the variational parameters may be optimized by evaluating the outcome for the variational parameters on a measurement system 10 featuring controllable quantum systems 12.

Preferably, both the set of preparation gates 14 and the set of decoding gates 16 should have variational degrees of freedom, i.e., comprise variational quantum gates parametrized by variable actions, such that after the variational optimization, both unitary operators U_{En}, U_{De} may depend on the prior distribution P(ϕ).

The available quantum gates may depend on the plurality of controllable quantum systems 12 used to implement the measurement sequence.

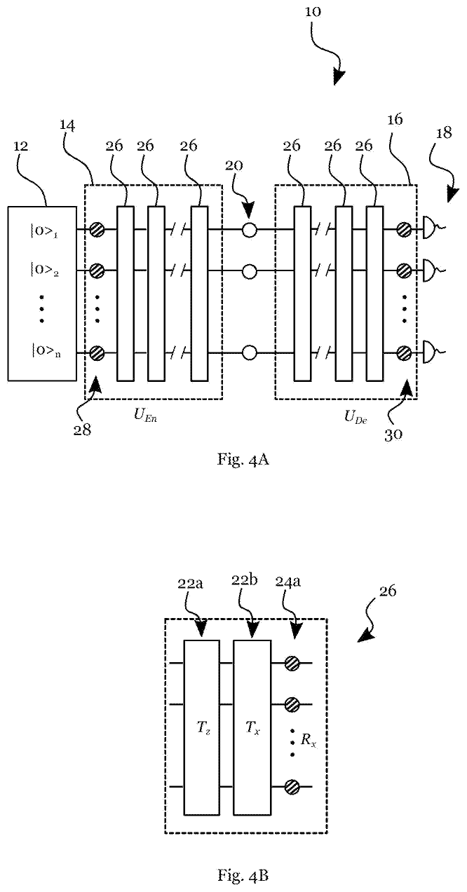

FIG. 4A schematically illustrates an example of a measurement system 10 for measuring a frequency of electromagnetic radiation. The system 10 comprises a plurality of controllable quantum systems 12, whose quantum state may be controllably evolved based on pulses of the electromagnetic radiation, e.g. implemented by trapped atoms or trapped ions. For example, qubits may be implemented in the ions in the ground state |0> and the excited state |1> of a radiative transition of ions trapped in a Paul trap.

The radiative transition between the ground state |0> and the excited state |1> may have a (resonant) transition frequency at or close to the frequency of the electromagnetic radiation, such that the plurality of controllable quantum systems 12 may act as sensitive probes of the frequency.

The set of preparation gates 14 and the set of decoding gates 16 implement unitary operators U_{En} and U_{De}, and are each composed of a number of n_{En} and n_{De} preparation/decoding layers 26, respectively.

FIG. 4B illustrates an example of the structure of one of the preparation/decoding layers 26, which comprises two non-linear quantum gates 22a, 22b acting on all of the plurality of controllable quantum systems 12, and a global rotation 24a of the states of the plurality of controllable quantum systems 12.

The illustrated example shows the non-linear quantum gates 22a, 22b as implemented by the one-axis twisting operator T_{μ} (θᵢ)=exp(−iθᵢJ_{μ}²), with η=x,y,z specifying the axis of rotation about respective variable twisting angles θᵢ the variable twisting angle θ₁ being the ith variable action, and the operator I_{μ} being given by j_{x,y,z}=½Σₖ₌₁^{N}σₖ^{x,y,z}, wherein N is the number of controllable quantum systems and σₖ^{x,y,z} are the Pauli operators. The one axis twisting operator may be implemented in ion traps via the Mølmer-Sørensen interaction and may induce entanglement between different ions in the ion trap.

However, the skilled person will appreciate that the one-axis twisting operations may also be exchanged for Rydberg dressing operations approximating the unitary operator D_{μ} (θ)=exp[−iθ(H_{μ}^{D}/V₀)], e.g. as realized in alkyne earth tweezer clocks, with H_{μ}^{D}, being the effective interaction Hamiltonian and V₀ corresponding to the interaction strength. Further, the one-axis twisting operations may be exchanged for other non-linear interactions between controllable quantum systems 12, such as exchange couplings between generalized spins or other next-neighbor interactions. Further, for controllable quantum systems 12 implemented in atoms with large spins, the non-linear quantum gate 22a, 22b may prepare individual atoms in non-classical states, e.g. squeezed spin states, and the non-classical state may accordingly not comprise entanglement between different controllable quantum systems 12.

The global rotation may be a native operation in the plurality of controllable quantum systems 12 or may be implemented by single rotations of all states of the plurality of controllable quantum systems 12, wherein the corresponding quantum operator may be given by Rₓ(θᵢ)=exp(−iθᵢJₓ). Each of the operations, e.g. angles θ₁, may be associated with a variational parameter, such that each layer may feature in principle three variable actions or three degrees of freedom, wherein two of the variational parameters may parametrize the actions of two non-linear entangling gates.

Although only one exemplary structure of a layer 26 is shown, the skilled person will appreciate that the order of the quantum operations in the layers 26 of the set of preparation gates 14 may be different from, or inverse to, the order of the quantum operations in the layers 26 of the set of decoding gates 16. Moreover, although a specific set of axes is provided in the example, different axes may be selected in some examples.

Preferably, the arrangement of the quantum gates of the set of preparation gates 14 and the set of decoding gates 16 is selected to result in an antisymmetric phase estimator ϕₑₛₜ as a result of the measurement, e.g. substantially fulfilling the relation ϕₑₛₜ(ϕ)=−ϕₑₛₜ(−ϕ) for values of the phase within the width δϕ of the pre-defined expected prior distribution. For example, the set of preparation gates 14 and the set of decoding gates 16 may be invariant under the spin x-parity transformation, e.g. via imposing PₓU_{En}R_{y}(−π/2)Pₓ=U_{En}R_{y}(−π/2) and PₓU_{De}Pₓ=U_{De}, with Pₓ=Rₓ(π/2), and the set of preparation gates 14 and the set of decoding gates 16 may be constructed according to

$${U}_{En} = [ {R}_{x} ( {θ}_{{n}_{En}}^{( 3 )} ) {T}_{x} ( {θ}_{{n}_{En}}^{( 2 )} ) {T}_{z} ( {θ}_{{n}_{En}}^{( 1 )} ) … {R}_{x} ( {θ}_{1}^{( 3 )} ) {T}_{x} ( {θ}_{1}^{( 2 )} ) {T}_{z} ( {θ}_{1}^{( 1 )} ) ] {R}_{y} ( \frac{π}{2} ) , \qquad ( 3 )$$

$${U}_{De} = {R}_{x} ( \frac{π}{2} ) [ {T}_{z} ( {ϑ}_{1}^{( 1 )} ) {T}_{x} ( {ϑ}_{1}^{( 2 )} ) {R}_{x} ( {ϑ}_{1}^{( 3 )} ) … {T}_{z} ( {ϑ}_{{n}_{De}}^{( 1 )} ) {T}_{x} ( {ϑ}_{{n}_{De}}^{( 2 )} ) {R}_{x} ( {ϑ}_{{n}_{De}}^{( 3 )} ) ] , \qquad ( 4 )$$

wherein θᵢ^{(j)}, ϑᵢ^{(j)} are the jth variational parameter of the ith layer of the set of preparation gates 14 and the set of decoding gates 16, respectively. The resulting measurement may comprise optimal sensitivity around phase values of ϕ=0. The skilled person will appreciate that the gate

$${R}_{x} ( \frac{π}{2} )$$

in the set of decoding gates 16 may be replaced by

$${R}_{y} ( \frac{π}{2} ) ,$$

e.g. to obtain optimal sensitivity for phase values around

$$ϕ = \pm \frac{π}{2} .$$

Additionally or alternatively, the set of preparation gates 14, the coherent evolution 20, or the set of decoding gates 16 may comprise a phase shift, e.g. based on the operator R_{z}(β), to shift the phase value associated with optimal sensitivity by β. The skilled person will further appreciate that other non-linear operators, such as the Rydberg dressing operator D_{μ}, may satisfy the same symmetry constraints, such that Tₓ (θ/ϑ), T_{Z} (θ/ϑ) in Eqs. (3), (4) may be replaced by Dₓ(θ/ϑ), D_{Z} (θ/ϑ), respectively, in some examples.

Following the initialization of the plurality of controllable quantum systems 12, the illustrated measurement sequence comprises an interaction with the electromagnetic interaction and the plurality of controllable quantum systems 12, e.g. a pulse of the electromagnetic radiation. The pulse of the electromagnetic radiation may induce a first global rotation 28 of the states of the plurality of controllable quantum systems 12. The first global rotation 28 may induce superposition states of the ground state |0> and the excited state |1>of the plurality of controllable quantum systems 12, and may lock the phase of the superposition state to the phase of the electromagnetic radiation. For example, the first global rotation may induce a rotation of the states of the plurality of controllable quantum systems 12 by substantially π/2, such as to induce an equal superposition of the ground state |0> and the excited state |1>.

The superposition states of the plurality of controllable quantum systems 12 may be non-classical, e.g. spin squeezed or entangled by the unitary operator U_{En} via the further gates of the set of preparation gates 14. The application of the set of preparation gates 14 may be followed by a interrogation period 20 in which the states of the plurality of controllable quantum systems 12 may freely evolve. Over the interrogation period 20, the states of the plurality of controllable quantum systems 12 may accumulate a phase with respect to the phase of the electromagnetic radiation. The value of the phase may be based on the interrogation time 20 and the detuning between the frequency of the electromagnetic radiation and of the transition frequency of the plurality of controllable quantum systems 12, resulting in an evolved state of the plurality of controllable quantum systems 12.

The evolved state may be subjected to the action of the set of decoding gates 16, which may comprise a second global rotation 30 of the states of the plurality of controllable quantum systems 12. The second global rotation 30 may induce a similar rotation of the states of the plurality of controllable quantum systems 12 as the first global rotation 28, e.g. may correspond to a second π/2 pulse. The set of decoding gates 16 including the second global rotation 30 may project the evolved state onto the ground state |0> or the excited state |1> based on the accumulated phase, such that a proportion of the plurality of controllable quantum systems 12 in either state may be indicative of the accumulated phase.

For example, the detection system 18 may measure a population of the ground state |0> or the excited state |1> for the plurality of controllable quantum systems 12, e.g. via state selective fluorescence of atoms. For example, the detection system 18 may measure a number N_{excited} of controllable quantum systems 12 in the excited state |1> or a number N_{ground} of controllable quantum systems 12 in the ground state |0>.

Based on the measurement, a classical computation system (not shown) may determine an outcome m, e.g. m=N_{excited}−N_{ground}, and may determine an estimated phase ϕₑₛₜ via the mapping function ϕₑₛₜ(m), which is preferably a strictly monotonic function of the outcome m at least over the stochastic width δϕ of the pre-defined expected prior distribution.

For example, the mapping function may be a linear function of the outcome, e.g. (pₑₛₜ=α*m, wherein α may be a pre-defined constant. The constant α may be numerically or empirically optimized for given sets of preparation and decoding gates 14, 16 and for a pre-defined expected prior distribution having a certain stochastic width δϕ. Hence, depending on a stochastic width δϕ of the pre-defined expected prior distribution, a suitable constant α may be selected for optimizing the variable actions as well as for determining the derived value, e.g. the estimated phase ϕₑₛₜ.

In principle, an optimal parameter α may be selected analytically or numerically, e.g. depending on the prior distribution, and the variable actions may be optimized with a fixed parameter α. However, α may equally be analytically or numerically selected for each iteration of the variational optimization, such that the cost function is minimized. Moreover, the mapping function need not be linear, but may also be selected as part of the variational optimization, e.g., the mapping function may be selected as a minimum mean squared error estimator given a realization of the preparation and decoding circuits 14, 16.

The estimated phase ϕₑₛₜ may be a function of the interrogation time 20, which may correspond to a time between applying the first pulse 28 and applying the second pulse 30. Based on the estimated phase ϕₑₛₜ and the interrogation time 20 a frequency detuning between the transition frequency and the frequency of the electromagnetic radiation may be determined.

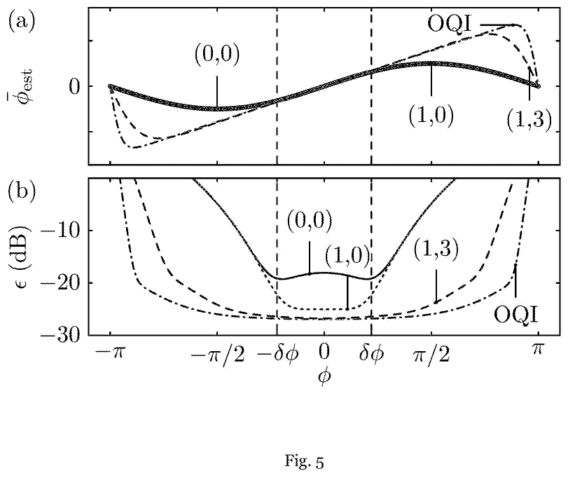

FIG. 5 illustrates the result of calculations of the performance of a measurement sequence as illustrated in FIG. 4A wherein the variable actions of the parametrized quantum circuit have been optimized according to the cost function in Eqs. (1, 2) with a normal distribution centered on zero phase and having a standard deviation (width) of δϕ≈0.7 as the pre-defined expected prior distribution. The different curves correspond to measurement sequences with a set of preparation gates 14 and a set of decoding gates 16 with different numbers (n_{En}, n_{De}) of layers 26 for constructing the unitary operators U_{En}, U_{De}, with each layer 26 comprising 3 variational parameters, as given by Eqs. (3), (4).

The subfigure FIG. 5(a) shows the estimated phase ϕₑₛₜ as a function of the actual phase 4), while the subfigure FIG. 5(b) illustrates the phase dependence of the estimation error ϵ(ϕ). The width of the pre-defined expected prior distribution δϕ is indicated by vertical lines. The lines associated with (0, 0) correspond to a measurement without entanglement, i.e. a standard Ramsey interferometer with coherent probe states. The lines associated with “OQI” correspond to the theoretical bound on an optimal quantum interferometer for the pre-defined expected prior distribution, as discussed by Macieszczak et al. As can be seen from the lines associated with the (1, 0), a set of preparation gates 14 can reduce the estimation error ϵ(ϕ) close to zero phase, but the dynamic range of the associated interferometer remains substantially constant. However, as can be seen from the lines associated with the (1, 3), entanglement at the measurement stage as introduced by a set of decoding gates 16 can optimize both the estimation error ϵ(ϕ) and the dynamic range. Further, the measurement sequence may approximate the optimum quantum interferometer at a comparatively low number of coherent operations, e.g. including 12 variational gates, parametrized by 12 variable actions. In some examples, the set of preparation and the set of decoding gates comprise less than 30 variable actions individually or in total.

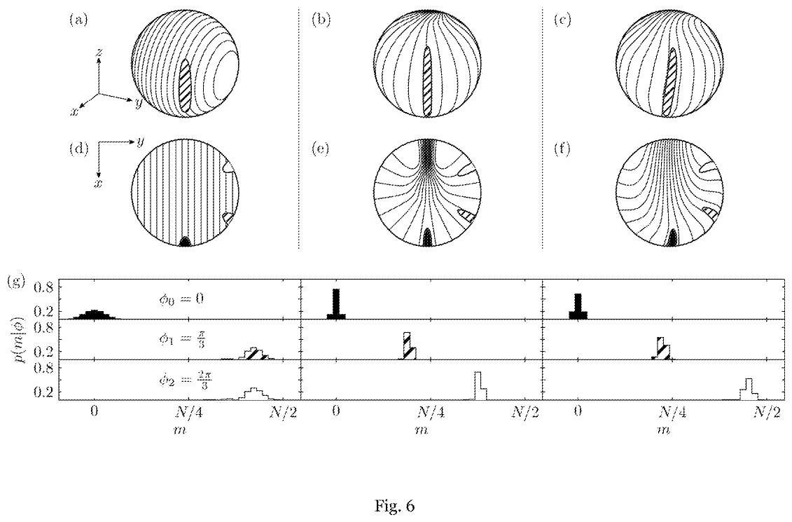

FIG. 6 shows a visualization of quantum states for the measurement sequence discussed in connection with the example of FIG. 5. The subfigures (a)-(f) illustrate the quantum states |ψ_{ϕ} [symbol] =exp(−iϕJ_{z})|ψᵢₙ [symbol] of the evolved state and quantum measurement operators as Wigner distributions on a generalized Bloch sphere for N=64 and δϕ≈0.7. The first (a,d), second (b,e), and third column (c,f) correspond to (n_{En}, n_{De})=(1, 0), the optimal quantum interferometer, and to a (1, 3) quantum circuit, respectively. Measurement operators are visualized as different contours on the Bloch sphere corresponding to different measurement outcomes. The corresponding optimized states |ψ_{ϕ} [symbol] are shown at selected phases ϕ₀=0, ϕ₁=π/3, and ϕ3=2π/3 as filled, dashed, and empty areas, respectively. Subfigure (g) illustrates the measurement probability p(m|ϕ) corresponding to the overlap between the contours of the measurement distribution and the respective state distribution, displayed in the same column.

The visualization of the quantum state in the first column shows that the example optimized with a (1, 0) parametrized quantum circuit features a spin squeezed state, squeezed along the z-direction. However, the measurement is ambiguous for the phase values of ϕ₁=π/3, and ϕ3=2π/3, as it results in indistinguishable distributions of the measurement probability p(m|ϕ). Conversely, the angles can be resolved in the second and third columns, wherein the shape of the measurement operators shows eigenstates with well defined phases, wherein the contours of the measurement operator overlap favorably with the shape of the non-classical state prepared by the set of preparation gates 14. As can be seen from subfigures FIGS. 3(c), (f), the non-classical state prepared by the set of preparation gates 14 may deviate from a conventional spin-squeezed state, e.g. as prepared by the OQI, but features a twisted shape, and the measurement operator may feature corresponding similarly shaped contours for different outcomes. The twisted shape of the evolved state and the measurement may be a consequence of a restricted gate set available for the variational optimization in the example of FIGS. 4A, 4B.

Nonetheless, the method illustrated in conjunction with FIGS. 4A, 4B may approximate the OQI even for a low circuit depth, wherein the variational optimization of both the set of preparation gates 14 and the set of decoding gates 16 may compensate for a limited universality of the underlying quantum gates.

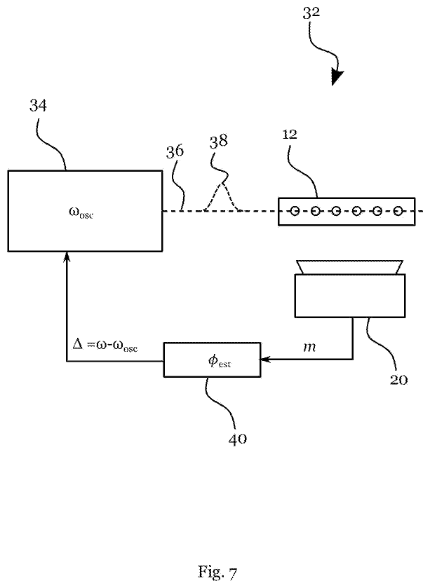

FIG. 7 illustrates a clock 32 based on the measurement sequence illustrated in the example of FIG. 4a, 4B. The clock 32 comprises an oscillator 34 generating electromagnetic radiation 36 at a clock frequency ω_{OSC} and a plurality of controllable quantum systems 12, implemented as ions in a trap or neutral atoms in tweezers or optical lattices.

The clock 32 is configured to implement the measurement sequence illustrated in the example of a measurement system 10 in FIG. 4A using pulses 38 of the electromagnetic radiation 36 at least for inducing a first rotation 28 and a second rotation 30 of the states of the plurality of controllable quantum systems 12. The clock 32 is further configured to apply a set of preparation gates 14 and a set of decoding gates 16 to the plurality of controllable quantum systems 12 before and after an interrogation time 20, which may equally be based at least partially on electromagnetic radiation of the oscillator 34.

The clock further comprises a detection system 20 adapted to measure a state of the plurality of controllable quantum systems 12, e.g. based on state selective fluorescence of the ions, generating an outcome m.

A classical computation system 40 is configured to map the outcome of the measurement to a phase ϕ through the mapping function ϕₑₛₜ(m), and may determine a detuning Δ=ω−ω_{OSC} between the clock frequency ω_{OSC} and a resonant transition frequency co of the controllable quantum systems 12. A control signal based on the detuning Δ or based on the phase may be fed back to the oscillator 34 to adjust the clock frequency ω_{OSC}, thereby stabilizing the oscillator 34 to the transition frequency ω.

Persons skilled in the art will readily understand that these advantages (as well as the advantages indicated in the summary) and objectives of this system would not be possible without the particular combination of computer hardware and other structural components and mechanisms assembled in this inventive system and described herein. It will be further understood that a variety of programming tools, known to persons skilled in the art, are available for implementing the features and operations described in the foregoing material. Moreover, the particular choice of programming tool(s) may be governed by the specific objectives and constraints placed on the implementation plan selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f).

The disclosure may be embodied in other specific forms without departing from the spirit or essential characteristics thereof. For example, each of the new components described herein, may be modified to suit particular variations or requirements while retaining their basic configurations or relationships with each other or while performing the same or similar functions described herein. The present embodiments are therefore to be considered in all respects as illustrative and not restrictive. Accordingly, the scope of the disclosure can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A method of measuring a physical quantity, the method being implemented in a hybrid classical-quantum system, the hybrid classical-quantum system comprising a parametrized quantum circuit on the basis of a plurality of controllable quantum systems and further comprising a classical computation system, the method comprising the steps of:
a) initializing the plurality of controllable quantum systems in an initial state;
b) applying a set of preparation gates to the plurality of controllable quantum systems for preparing the plurality of controllable quantum systems in a non-classical state,
c) evolving the non-classical state over a time period for obtaining an evolved state of the plurality of controllable quantum systems;
d) applying a set of decoding gates to the plurality of controllable quantum systems in the evolved state;
e) performing a measurement of the plurality of controllable quantum systems; and
f) determining a derived value of the physical quantity based on a mapping function between an outcome of the measurement and the physical quantity on the classical computation system;
wherein the set of preparation gates and the set of decoding gates each comprise non-linear quantum gates suitable for generating a non-classical state of the plurality of controllable quantum systems and each comprise variational quantum gates characterized by variable actions onto controllable quantum systems of the plurality of controllable quantum systems; and
wherein the variable actions are variationally optimized to find an extremal value of a cost function, wherein the cost function averages an estimation error of the derived value over a pre-defined expected prior distribution of the physical quantity.

2. The method of claim 1, wherein the cost function is mathematically equivalent to
C=∫dϕϵ(ϕ)P(ϕ)
wherein ϕ is the physical quantity, ϵ(ϕ) is the average estimation error for a given value of the physical quantity, and P(ϕ) is the pre-defined expected prior distribution of the physical quantity.

3. The method of claim 2, wherein the estimation error ϵ(ϕ) is the average mean square error of the derived value with respect to an actual value of the physical quantity.

4. The method of claim 3, wherein ϵ(ϕ) is mathematically equivalent to
ϵ(ϕ)=∫dx[(ϕ−ϕₑₛₜ(x)]²p(x|ϕ)
wherein x is the outcome, ϕₑₛₜ(x) is the mapping function mapping the outcome x to the derived value of the physical quantity, ϕ is the actual value of the physical quantity, and p (x|ϕ) is the conditional probability of measuring the outcome x when the actual value of the physical quantity is ϕ.

5. The method of claim 1, wherein the pre-defined expected prior distribution approximates or is mathematically equivalent to a Normal distribution centered around an expected mean value of the physical quantity or the derived value.

6. The method of claim 1, wherein the derived value is a periodic function with respect to changes of the physical quantity, and the pre-defined expected prior distribution is associated with a standard deviation δϕ smaller than a period of the periodic function.

7. The method of claim 1, wherein the derived value is a periodic function with respect to changes of the physical quantity, and the pre-defined expected prior distribution is associated with a standard deviation 67 ϕ greater than 1/N of the period of the periodic function, wherein N is the number of controllable quantum systems.

8. The method of claim 1, wherein the plurality of controllable quantum systems implement a plurality of two-level-systems, and wherein the mapping function maps a difference between the number of controllable quantum systems in an excited state and in a ground state of the plurality of two-level-systems to the derived value of the physical quantity.

9. The method of claim 8, wherein the mapping function is mathematically equivalent to a linear function of the difference at least over a standard deviation of the pre-defined expected prior distribution.

10. The method of claim 1, wherein the physical quantity is an oscillating frequency of electromagnetic radiation interacting with the plurality of controllable quantum systems prior to and after step c), and wherein the derived value is a phase originating from a difference in the oscillating frequency and a resonant frequency of the plurality of controllable quantum systems.

11. A clock comprising:
an oscillator for generating electromagnetic radiation associated with an oscillator frequency;
a plurality of controllable quantum systems implementing a corresponding plurality of two-level systems, wherein an energy difference of the two-level systems corresponds to a target clock frequency of the clock;
a controller configured to:
a) initialize the plurality of controllable quantum systems in an initial state;
b) apply a set of preparation gates to the plurality of controllable quantum systems,
c) permit an evolution of the plurality of controllable quantum systems over a time period;
d) apply a set of decoding gates to the plurality of controllable quantum systems;
e) determine a measurement outcome of the plurality of controllable quantum systems; and
f) determine a feedback onto the oscillator based on a mapping function between the measurement outcome and a derived frequency difference between the oscillator frequency and the target clock frequency associated with the plurality of two-level systems;
wherein before and after the evolution of the plurality of controllable quantum systems over the time period, the controller drives a state rotation of each of the plurality of controllable quantum systems using the electromagnetic radiation of the oscillator to implement a Ramsey interferometer; and
wherein the set of preparation gates and the set of decoding gates each comprise non-linear quantum gates suitable for generating a non-classical state of the plurality of controllable quantum systems and each comprise variational quantum gates characterized by variable actions onto at least one of the plurality of controllable quantum systems; and
wherein values of the variable actions are the result of a variational optimization of the variable actions based on a cost function, wherein the cost function averages an estimation error of the derived value over a pre-defined expected prior distribution of the physical quantity.

12. The clock of claim 11, wherein the plurality of controllable quantum systems are implemented in a corresponding plurality of atoms.

13. The clock of claim 11, wherein the controller drives a global rotation of the states of the plurality of controllable quantum systems by an angle of substantially π/2 to implement the Ramsey interferometer.

14. The clock of claim 11, wherein the pre-defined expected prior distribution corresponds to an expected statistical distribution of the actual value after the evolution over the time period.

15. The clock of claim 11, wherein the set of preparation gates and the set of decoding gates each implement global rotations of the states of the plurality of controllable quantum systems approximating the operator R_{μ} (θ₁)=exp(—iθ₁J_{μ}) and a variational non-linear quantum gate selected from the group of a generalized exchange coupling approximating the operator G (t)=exp[−iHt], with H=Σ_{k,l=1}^{N}j_{k,l}σₖ^{μ}σᵢ^{ν}+ΣₖΔₖσₖ^{ρ}or H=Σ_{k,l=1}^{N}j_{k,l}σₖ^{μ}σₗ^{μ}+ΣₖΔₖσₖ^{ν}and with j_{k,l} representing a generalized coupling strength between controllable quantum systems k,l, a one-axis twisting operation of the states of the plurality of controllable quantum systems approximating the operator Tᵤ (θ₂)=exp(−iθJᵤ²), and a Rydberg dressing operation approximating the unitary operator Dᵤ (θ₂)=exp [−iθ₂ (Hᵤ^{D}/V₀)], with Hᵤ^{D} being the effective interaction Hamiltonian and V₀ corresponding to the interaction strength, with μ, ν, ρ specifying the axis of rotation about respective variable angles θ₁, θ₂, the variable angles θ₁, θ₂ and j_{k,l} or a function thereof being the respective variable actions.

16. The clock of claim 11, wherein the set of preparation gates and the set of decoding gates each comprise a number of n_{En} and n_{De} layers of quantum gates, respectively, wherein n_{En} and n_{De} are positive integer numbers, and wherein each layer comprises at least one non-linear quantum gate and is parametrized by at least one variable action.

17. The clock of claim 16, wherein n_{En} is equal to or smaller than n_{De}.

18. A method of optimizing a measurement of a physical quantity with a hybrid classical-quantum system comprising a plurality of controllable quantum systems, the method comprising the steps of:
a) initializing a number of variational parameters, the variational parameters parametrizing variable actions of variational quantum gates for acting onto the plurality of controllable quantum systems;
b) repeatedly implementing a measurement sequence of known values of the physical quantity using the plurality of controllable quantum systems, the measurement sequence having the steps of:
initializing the plurality of controllable quantum systems in an initial state;
applying a set of preparation gates to the plurality of controllable quantum systems for preparing the plurality of controllable quantum systems in a non-classical state,
evolving the non-classical state for obtaining an evolved state of the plurality of controllable quantum systems evolved according to a select one of the known values;
applying a set of decoding gates to the plurality of controllable quantum systems in the evolved state; and
determining a measurement outcome of the evolved state for the select one of the known values;
wherein the set of preparation gates and the set of decoding gates each comprise non-linear quantum gates suitable for generating a non-classical state of the plurality of controllable quantum systems, and each comprise variational quantum gates characterized by variable actions onto controllable quantum systems of the plurality of controllable quantum systems;
c) mapping each of the measurement outcomes to a corresponding derived value of the physical quantity according to a mapping function;
d) determining a cost parameter according to a cost function which averages an estimation error between the derived values and the corresponding known values over a pre-defined expected prior distribution of the physical quantity;
e) selecting updated variational parameters to reduce the cost parameter;
f) iteratively repeating steps b) to e) towards variational parameters associated with a minimized cost parameter.

19. The method of claim 18, wherein selecting updated variational parameters to reduce the cost parameter comprises estimating an energy landscape or a gradient of the cost function with respect to the variational parameters.

20. The method of claim 19, wherein estimating the energy landscape or the gradient comprises repeatedly implementing the sequence b) to e) with shifted variational parameters, the shifted variational parameters comprising a subset of the variational parameters being shifted with respect to a current set of variational parameters.
